(19) United States
(12) Patent Application Publication
(10) Pub. No.: US 2010/0201040 A1
(43) Pub. Date: Aug. 12, 2010

(54) INDUCTION HEATING DEVICE AND METHOD FOR MAKING PARTS USING SAME

(75) Inventors: Alexandre Guichard, La Chapelle du Mont du Chat (FR); Jose Feigenblum, Grenoble (FR)

Correspondence Address: RATNERPRESTIA, P.O. BOX 980, VALLEY FORGE, PA, 19482, US

(73) Assignee: ROCTOOL, Le Bourget du Lac (FR)

(21) Appl. No.: 11/993,159

(22) PCT Filed: Apr. 11, 2006
(86) PCT No.: PCT/FR2006/050338

§ 371 Date: Dec. 19, 2007

(30) Foreign Application Priority Data
Jun. 22, 2005 (FR) 0551717

(51) Int. Cl. B29C 35/12; H05B 6/10

(52) U.S. Cl. 264/403; 219/600; 219/632; 219/660; 425/117

(57) ABSTRACT

The invention concerns a device for heating a surface by induction, in particular for molding or transforming a part made of thermoplastic or thermosetting composite material. The device comprises a body having at least one portion made of magnetic and heating conducting material wherein is provided a plurality of closed cavities proximate the surface to be heated, each cavity surrounding a field winding. The heat produced by induction on the walls of the cavity is transferred by conduction to the heating surface. The distance between the cavities and the position of said cavities relative to the heating surface are such that the heating is substantially uniform on said surface.

The invention relates to a method and a device for heating a metal surface by induction, in particular in order to carry out a molding or transformation, especially of thermoplastic or thermosetting matrix composite materials.

To heat a metal surface in order to carry out especially a molding of a part made of plastic or composite part, there is a known way of burying inductive wires in a volume of resin or the like, the surface of this volume to be heated comprising a plate made of magnetic material, this plate being called a “susceptor”. The heating is obtained by electromagnetic coupling between the inductors and the magnetic plate.

This technology has major drawbacks that make it difficult to exploit. Indeed, the heating of the susceptor is not homogeneous because it is the maximum at the position of each inductive wire and diminishes between these positions. Furthermore, since resin is a thermal insulator it is not easy to obtain the cooling necessary between two duty cycles. Furthermore, the heating and cooling cycles may alter the mechanical properties of this resin. Finally, resin has low resistance to impact.

The invention overcomes these drawbacks.

The device of the invention comprises a body having at least one part made of magnetic and heat-conductive material, with a plurality of closed cavities in the proximity of the surface to be heated, each cavity surrounding an inductor, the heat produced by induction on the walls of the cavity being transferred by conduction to the heating surface, the inter-cavity distance and the position of these cavities relative to the heating surface being such that the heating is substantially uniform on this surface.

The magnetic and conductive material is, for example, steel.

Thus, the heating of the surface is uniform, and the efficiency is high since the coupling between each inductor and the corresponding cavity is the optimum, with the cavity completely surrounding the inductor. Furthermore, the material of the body of the heating surface may be less sensitive to ageing than a resin.

Since the magnetic material constituting the body of the device is a thermal conductor, the cooling can be done efficiently.

In one embodiment, to minimize thermal losses by conduction on the opposite side to the heating surface, the part of the body that is on the opposite side to the surface to be heated relative to the cavities is made of a non-magnetic material.

In one embodiment, the cavity take the form of grooves in two parts of the body, the first part which ends in the surface to be heated being made of magnetic material and the second part, opposite the surface, being made for example of non-magnetic material.

The grooves, and therefore the cavities, may have any unspecified section, for example a circular section or a square or rectangular section.

In one embodiment, for the cooling between two surface-heating cycles, there are provided channels designed to be crossed by a cooling fluid, these channels being located between the cavities and the heating surface. The channels have for example a direction parallel to the cavities. As a variant, they have a direction perpendicular to the cavities.

According to one embodiment, each inductor has a tubular shape in which the central channel serves for the circulation of a cooling fluid. This cooling of the inductors can also serve for the cooling of the body of the device between two heating cycles.

As a variant, the inductive tube is preferably lined with an insulator on its external surface and the external surface of the tube, possibly the external surface of the insulator, is at a distance from the internal wall of the cavity so as to make a ring-shaped space for the circulation of another cooling fluid designed to cool the body between two heating cycles. Thus, with this embodiment, the space requirement of the cooling means is minimized. Furthermore, the positioning of the inductors in their cavity can be done easily.

With this last-mentioned embodiment, the thermal losses are minimized because, during the induction heating, the air between the walls of the cavity of the inductor constitutes a thermal insulator since of course the fluid for cooling between two cycles does not flow during this heating phase.

In another embodiment, the space between each inductor of the internal wall of the cavity is entirely filled with an electrical insulator.

In one embodiment, a heating apparatus comprises two devices of the type defined here above, for example one forming a die and the other forming a punch. The two devices can be powered in such a way that their temperatures are different, for example so as to obtain different surface states on a same part.

The surfaces to be molded may have any unspecified surface area.

The invention also relates to a method for the manufacture of parts by molding or transformation by means of at least one heating surface using the device as defined here above. It also relates to a method for the manufacture of parts by molding or transformation by means of an apparatus comprising at least two of these devices.

Other features and advantages of the invention shall appear from the description of some of its embodiments, this description being made with reference to the appended drawings, of which:

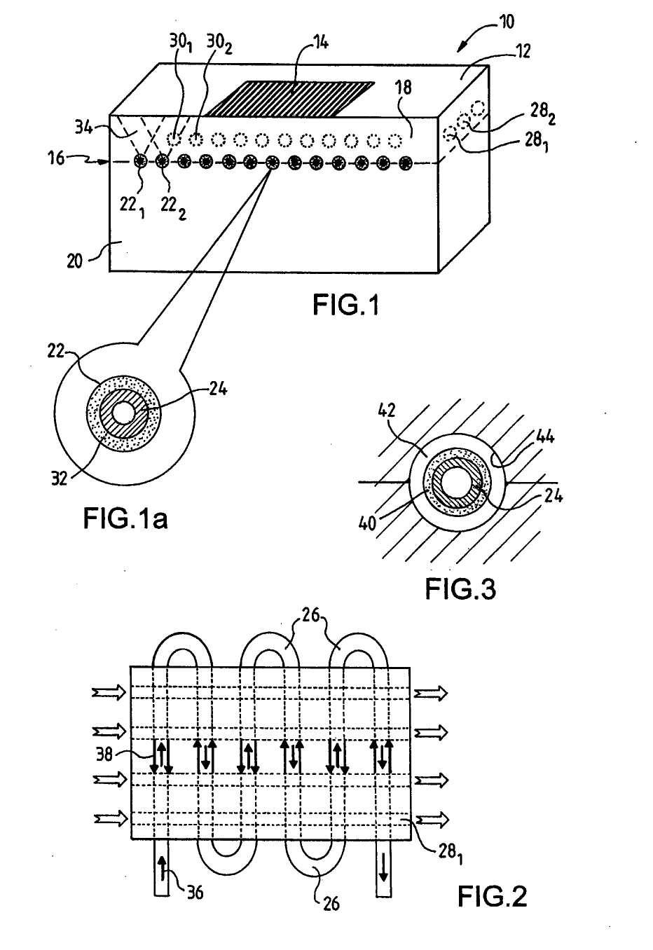

FIG. 1 is a drawing of a device according to the invention,

FIG. 1a shows a part of the device shown in FIG. 1,

FIG. 2 is a top view of a device shown in FIG. 1,

FIG. 3 is a drawing showing an alternative embodiment of the cooling means for the device shown in FIG. 1, and

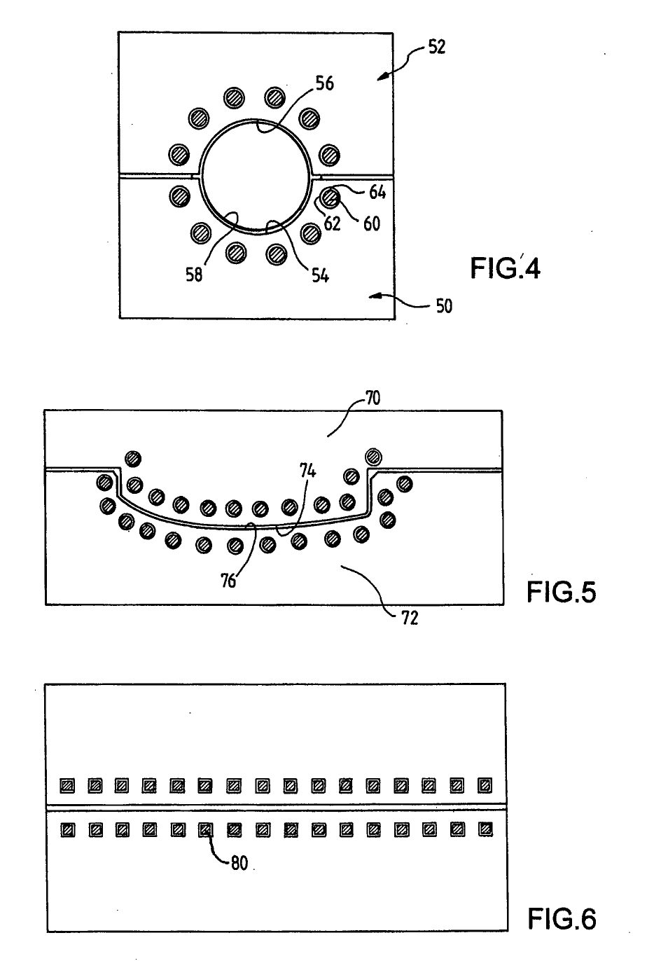

FIGS. 4, 5 and 6 are drawings of examples of molds according to the invention.

In the example shown in FIG. 1, the device 10 constitutes the half portion of a mould for the shaping and/or transformation of a part by heating. Thus, in this example, the device 10 forms the lower part of a mould, the upper part of which is not shown.

In this device 10, it is therefore necessary to heat the upper face 12 in order to transform or mould a part 14.

According to the invention, to keep the surface 12, the device 10 comprises a body 16 which, in the example, has two parts, 18 and 20 respectively. These two parts are made of steel. The part 18 is made of magnetic steel while the part 20 is made of non-magnetic material, for example also steel.

The part 18 made of magnetic material is the one comprising the heating surface 12. The lower portion of this part 18, which has a generally parallelepiped shape in the example, has circular, square or rectangular sectioned grooves with identical grooves of the part 20 of the body 16 corresponding to them. Thus, when the part 18 and 20 are assembled as shown, the grooves form channels or cavities 22₁, 22₂, etc. each of which is designed to hold an electrical conductor 24, for example made of copper, which is crossed, for the heating, by an alternating current at high frequency, for example a frequency ranging from 100 to 200 KHz, in order to induce an electromagnetic field.

As can be seen in FIG. 2, the various conductors 24 are connected to one another by jumpers 26.

In the example shown in FIG. 1 and FIG. 2, the magnetic part 18 of the body 16 is crossed by channels 28₁, 28₂, etc. having a general direction perpendicular to the channels 22₁, 22₂. These channels 28₁, 28₂, . . . are designed to receive a cooling fluid between two heating cycles. As a variant, there may be provided cooling channels 30₁, 30₂ having a direction substantially parallel to the cavities 22₁, 22₂, etc.

In another variant, which shall be described further below with FIG. 3, the cooling is done in the cavities 22.

In the example shown in FIGS. 1 and 1a, the conductor 24 is tubular so as to bring about a circulation of fluid for cooling the conductor, and it is insulated from the internal walls of the cavity 22 by a ring-shaped and insulating layer 32.

The working is as follows:

The high-frequency current, whose intensity is of the order of 100 to 200 KHz, crosses the conductor 24 and produces an electromagnetic field which, by coupling, heats the walls of the magnetic part of the cavity. The coupling is perfect since the cavity completely surrounds the conductor. Thus, losses are minimized.

The heat produced on the walls of the cavity is propagated to the surface 12 in a diffusion zone 34 having a substantially conical shape.

The distance from the cavities to the surface 12 and the distance between two adjacent cavities must be such that, on the surface 12, the diffusion zones 34 form an intersection so that the temperature of the surface 12 remains uniform.

However, in order to minimize heat losses, the distance from the cavities to the surface 12 should not be excessive.

The heat losses toward the rear, i.e. in the part 20 of the body 16, are minimized because the heat produced is produced by the magnetic part of the cavity and not by the non-magnetic part.

As shown in FIG. 2, the inductive currents 36 induce currents in opposite directions in the cavity.

In the variant shown in FIG. 3, to optimize the heating, there is no provision for cooling conduits of the type shown in FIG. 1 but the cooling is obtained in each cavity. Thus, the cavities 22 may be closer to the surface 12 and there is no obstacle to the propagation of heat towards the surface 12.

The tubular conductor 24 is lined with an insulating layer 40 and the section of this insulated conductor has a dimension substantially smaller then the section of the cavity 22. Thus a ring-shaped space 42 is made between the conductor 24 and the internal surface 44 of the cavity and, in this ring-shaped space 42, a fluid, in particular a liquid, for cooling of the body 16 is made to flow between two heating cycles.

During the heating, the ring-shaped zone 42 is filled with air. This feature thermally insulates the cavity of the tube 24. In other words, the heat produced in the part 18 of the body 16 makes practically no contribution to heating the tube 24.

In one embodiment, the part 14 to be processed has two surfaces that have to present different aspects. To this end, the upper part of the mould (not shown) has a device (not shown) similar to the device 10 described here above with a power supply to the inductors that is different from the power supply to the inductors of the lower device 10.

Thus, the heating temperature of the upper and lower parts may be different in order to give the different surface states.

This possibility of different temperatures is naturally not limited to different surface states. It may also entail, for example, the processing of parts made of materials that are different on each face.

FIG. 4 is a view in section of a mould compliant with the invention and designed to make a tube.

This mould therefore has two devices 50 and 52, each having a semi-cylindrical cavity, respectively 54 and 56. These cavities are heated as described here above, in particular as described with reference to FIGS. 1 and 3. The material 58 to be shaped as a tube by the heating operation is applied by compressed air against the induction-heated walls 54, 56.

In each of the devices, the inductors are evenly distributed in a magnetic material around the surfaces 54, 56. Each of these inductors and the cooling means of the mould are of the type shown in FIG. 3, i.e., each copper conductor 60 is tubular to let a cooling fluid circulate within, and between this conductor 60 and the cavity 62 made of magnetic material, a ring-shaped space 64 is made, filled with air during the molding. In this space 64, a cooling fluid flows between two molding cycles.

FIG. 5 is a view similar to that of FIG. 4 but pertains to the molding of a part made of composite material having, for example, the shape of an element of an automobile body such as a hood. In this case, there is provided a device 70 forming a punch and another device 70 forming a die. The inductors distributed in the vicinity of the molding surfaces, 74 and 76 respectively, so that, as described already, uniform temperatures are obtained on these surfaces.

Finally, FIG. 6 represents a mould used to obtain a flat plate. This embodiment is distinguished from the one shown in FIGS. 4 and 5 by the fact that the conductors 80 have, in this case, a rectangular or square section and that similarly the cavities have a rectangular or square section.

1. Device for heating a surface by induction, in particular in order to carry out a molding or transformation of a part made of thermoplastic or thermosetting composite material, comprising a body (16) having at least one part (18) made of magnetic and heat-conductive material, with a plurality of closed cavities in the proximity of the surface (12) to be heated, each cavity surrounding an inductor (24), the heat produced by induction on the walls of the cavity being transferred by conduction to the heating surface, the inter-cavity distance and the position of these cavities relative to the heating surface being such that the heating is substantially uniform on this surface.

2. Device according to claim 1 wherein the magnetic and heat-conductive material comprises steel.

3. Device according to claim 1 or 2 wherein the part of the body (20) that is on the opposite side to the surface to be heated relative to the cavities is made of non-magnetic material.

4. Device according to one of the claims 1 or 2 wherein each cavity is formed by the association of two grooves, one groove being formed in a surface of the part of the body made of magnetic material and the other groove being formed in a surface of another part of the body.

5. Device according to one of the claims 1 or 2 comprising conduits (28₁, 28₂; 30₁, 30₂) for the circulation of a cooling fluid between the cavities and the heating surface.

6. Device according to one of the claim 1 or 2 wherein each inductor has a section smaller than that of the cavity so as to form a ring-shaped space (42) for the circulation of a cooling fluid between two heating cycles of the surface to be heated.

7. Molding or transformation apparatus comprising at least two devices according to one of the 1 or 2 claims.

8. Apparatus according to claim 7 wherein the power supplies for the inductors of the two devices are distinct.

9. Method for making parts by molding or transformation by means of a heating surface, making use of a device according to one of the claims 1 or 2.

10. Method for making parts by molding or transformation by means of an apparatus according to claim 7.
